(19) United States
(12) Patent Application Publication
(10) Pub. No.: US 2016/0356338 A1
(43) Pub. Date: Dec. 8, 2016

(54) ATTACHMENT BRACKET FOR COUPLING WORK TOOL WITH MACHINE

(71) Applicant: Caterpillar Inc., Peoria, IL (US)

(72) Inventors: Jordan R. Beckhusen, Robinson, TX (US); Cody T. Moore, Waco, TX (US)

(73) Assignee: Caterpillar Inc., Peoria, IL (US)

(21) Appl. No.: 15/238,861

(22) Filed: Aug. 17, 2016

(51) Int. Cl. F16F 15/04

(52) U.S. Cl. CPC F16F 15/04

(57) ABSTRACT

The disclosure relates to an attachment bracket having a pin for coupling a work tool to a machine. The attachment bracket includes a base portion coupled with the work tool, and a mounting portion extending from the base portion and coupled with the machine. The mounting portion includes a first surface, a second surface, and a bore extending between the first surface and the second surface. The attachment bracket further includes a sleeve member received through the bore, and attached with the mounting portion. The attachment bracket further includes an isolation member received within the sleeve member. The isolation member includes a first structural sleeve, a second structural sleeve, and a dampening member disposed between the first structural sleeve and the second structural sleeve. The attachment bracket further includes a restraining member for restricting axial and rotational movement of the pin with respect to the mounting portion.

### TECHNICAL FIELD

The present disclosure relates to an attachment bracket for coupling a work tool with a machine.

### BACKGROUND

Work tool, such as hydraulic hammers is used at work sites to perform various operations, such as breaking up of large and hard objects and loosening of materials. The work tools are generally subjected to vibration while performing the various operations at the worksites. During operation, such vibration passes from the work tool to machine linkages trough an attachment bracket used for coupling the work tool with the machine linkages. In an example, a hydraulic hammer is coupled to a boom assembly of a machine, such as an excavator. The hydraulic hammer is coupled to the attachment bracket, which in turn is coupled to the boom assembly of the machine. During operation, the hydraulic hammer may operate at high frequencies and may further be exposed to damaging loads. Such high frequency and damaging loads may transfer to hydraulic cylinders and/or pin bores of the attachment bracket, thereby causing premature failures of the linkages of the machine.

U.S. Pat. No. 5,984,036, hereinafter referred to as the '036 patent, describes a rear side of an operator's cabin body resiliently supported by a rubber mount, and a front side of the operator's cabin body resiliently supported by a spring mount, of which a spring constant is set to be smaller than that of the rubber mount. Accordingly, a vibration transmissibility of pitching transmitted from a revolving frame to the operator's cabin body can be kept small, and pitching is damped by an oil damper which constitutes the rubber mount. Further, bounce and rolling transmitted to the operator's cabin body are converted into pitching for attenuation of vibration. However, the '036 patent fails to disclose an arrangement, which is less complex to design and develop, for minimizing impact caused to the operator cabin during operation of a machine.

### SUMMARY OF THE DISCLOSURE

In one aspect of the present disclosure, an attachment bracket having a pin for coupling a work tool to a machine is provided. The attachment bracket includes a base portion adapted to couple with the work tool. The attachment bracket further includes a mounting portion extending from the base portion, and adapted to couple with the machine. The mounting portion includes a first surface, a second surface, and a bore extending between the first surface and the second surface. The attachment bracket further includes a sleeve member received through the bore, and attached with the mounting portion. The attachment bracket further includes an isolation member received within the sleeve member. The isolation member includes a first structural sleeve, and a second structural sleeve coaxially disposed within the first structural sleeve, and adapted to receive at least a portion of the pin. The isolation member further includes a dampening member disposed between the first structural sleeve and the second structural sleeve. The attachment bracket further includes a restraining member adapted to restrict axial and rotational movement of the pin with respect to the mounting portion.

Other features and aspects of this disclosure will be apparent from the following description and the accompanying drawings.

### BRIEF DESCRIPTION OF THE DRAWINGS

FIG. 1 is a side view of a machine having a work tool coupled to a boom assembly of the machine;

FIG. 2 is a perspective view of an attachment bracket used for coupling the work tool with the boom assembly of the machine, according to an embodiment of the present disclosure;

FIG. 3 is a sectional view of a portion of the attachment bracket taken along a plane A-A′ of FIG. 2; and

FIG. 4 is a sectional view of a portion of an attachment bracket, according to another embodiment of the present disclosure.

### DETAILED DESCRIPTION

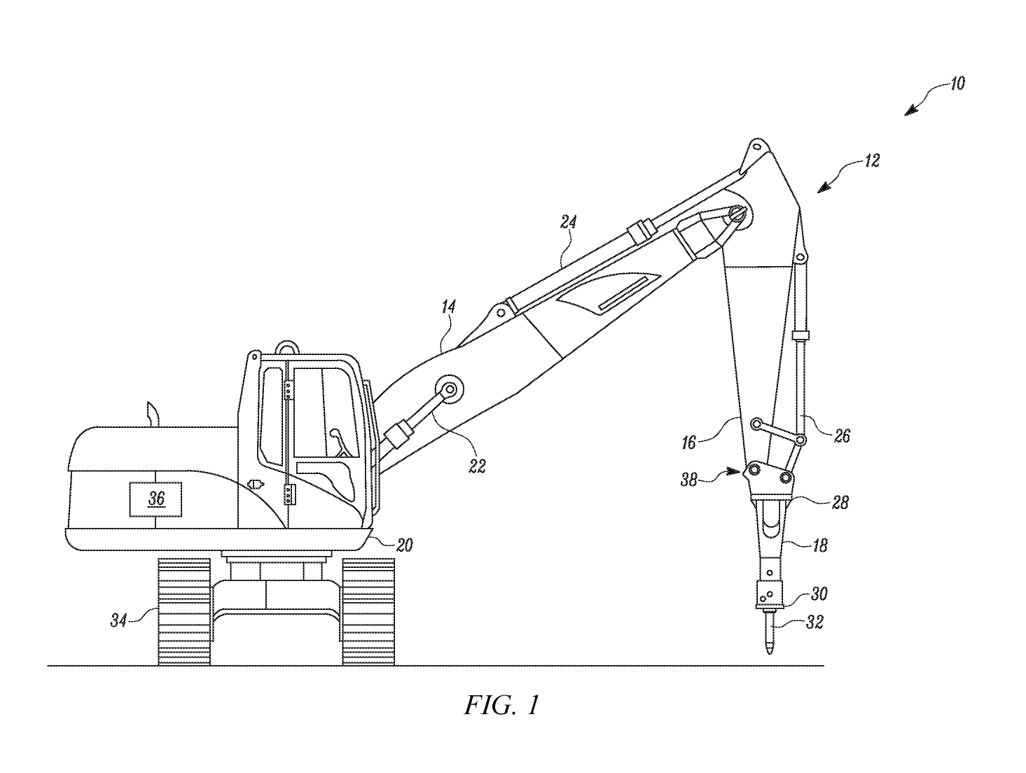

Referring to FIG. 1, a side view of a machine 10, such as an excavator, having a boom assembly 12 is shown. In other examples, the machine 10 may be, but not limited to, a material handler, and a front shovel. The boom assembly 12 includes a boom 14, a stick 16, and a work tool 18. The boom 14 is pivotally connected to a chassis 20 of the machine 10, the stick 16 is pivotally connected to the boom 14, and the work tool 18 is pivotally connected to the stick 16. The boom 14, the stick 16 and the work tool 18 are actuated by a first hydraulic actuator 22, a second hydraulic actuator 24, and a third hydraulic actuator 26, respectively. In the illustrated embodiment, the work tool 18 is a hydraulic hammer. In an example, the hydraulic hammer may be replaced with an excavator bucket previously associated with the excavator. As such, the hydraulic hammer may be operated by a hydraulic system of the excavator. The work tool 18 includes a first end 28 and a second end 30. The second end 30 of the work tool 18 includes a work piece 32 that is used for performing various operations, such as breaking up of large and hard objects and loosening of materials, at a worksite.

The machine 10 includes a drive system 34, such as tracks, for propelling the machine 10, and a power source 36 to power the boom assembly 12 and the drive system 34. The work tool 18 receives hydraulic fluid from the hydraulic system. The hydraulic fluid causes a piston (not shown) of the work tool 18 to move upward and downward, as such causes a vibratory motion to the work piece 32 of the work tool 18. Owing to such vibratory motion, the work tool 18 is subjected to high frequency of vibration and high loads.

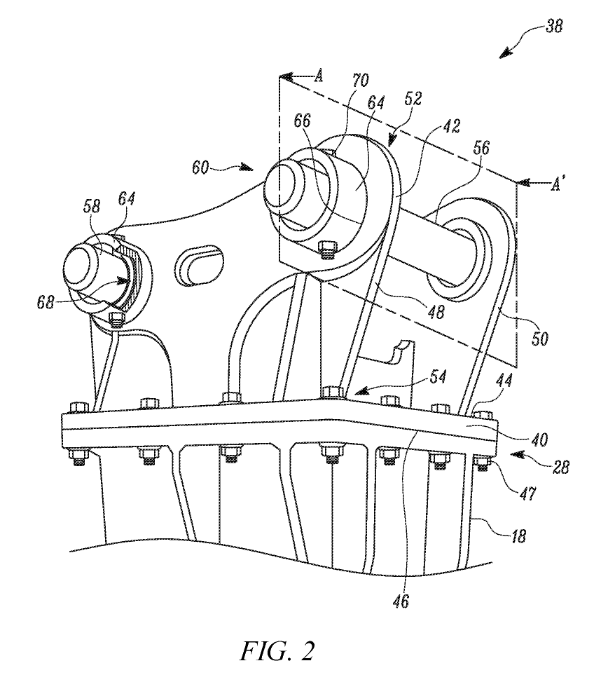

The machine 10 further includes an attachment bracket 38 for coupling the work tool 18 with the stick 16 of the boom assembly 12. Although, the attachment bracket 38 of the present disclosure is described with reference to the excavator, it may be understood that the attachment bracket 38 may be employed in other machines such as a vibratory plate compactor. The manner in which the attachment bracket 38 aids in coupling the work tool 18 with the stick 16 of the boom assembly 12 of the machine 10 is described with reference to FIG. 2.

Referring to FIG. 2, a perspective view of the attachment bracket 38 used for coupling the work tool 18 with the stick 16 of the boom assembly 12 of the machine 10 is shown. The attachment bracket 38 includes a base portion 40 coupled with the work tool 18 and a mounting portion 42 extending from the base portion 40. The base portion 40 includes a first surface 44 and a second surface 46. In particular, the base portion 40 is coupled to the first end 28 of the work tool 18 using multiple fastening members 47. In the illustrated embodiment, the attachment bracket 38 includes a pair of mounting portions 42, individually referred to as a first mounting portion 48 and a second mounting portion 50, extending from the base portion 40. Each of the first and second mounting portions 48, 50 includes a first end portion 52 and a second end portion 54. The attachment bracket 38 further includes a first pin 56 and a second pin 58 located at the first end portion 52 of each of the first and second mounting portions 48, 50. More specifically, the first pin 56 disposed at the first end portion 52 is coupled to the stick 16 of the machine 10 (as shown in FIG. 1). The second pin 58 disposed at the first end portion 52 is coupled to the third hydraulic actuator 26 of the boom assembly 12 (as shown in FIG. 1). The second end portion 54 is coupled to the base portion 40 of the attachment bracket 38 for coupling with the work tool 18 of the machine 10. Thus the first pin 56 and the second pin 58 disposed between the first and second mounting portions 48, 50 enable pivotal coupling of the work tool 18 with the stick 16 and the third hydraulic actuator 26.

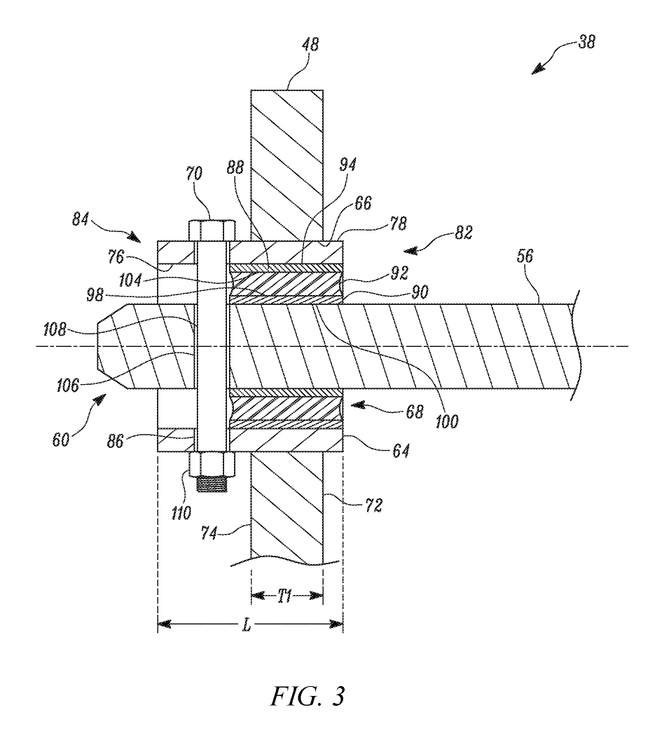

For illustration purpose of the present disclosure, the first pin 56 is explained in detail hereinbelow. Further, the first pin 56 is hereinafter referred to as ‘the pin 56’. The pin 56 includes a first end 60 supported by the first mounting portion 48 and a second end (not shown) supported by the second mounting portion 50. The attachment bracket 38 further includes a sleeve member 64 received through a bore 66 defined in each of the first mounting portion 48 and the second mounting portion 50. The sleeve member 64 is attached to the bore 66 of the mounting portions 42 such that the first end 60 and the second end of the pin 56 is received through the sleeve member 64 and supported by the first mounting portion 48 and the second mounting portion 50, respectively. The attachment bracket 38 further includes an isolation member 68 (shown in FIG. 3) received through the sleeve member 64 attached to each of the first mounting portion 48 and the second mounting portion 50. The first end 60 and the second end of the pin 56 are supported by the isolation member 68 disposed at each of the first mounting portion 48 and the second mounting portion 50. The isolation member 68 is used for isolating the high frequency of the vibration generated by the work tool 18 during the operation of the work tool 18. The attachment bracket 38 further includes a restraining member 70 to restrict axial and rotational movement of the pin 56 with respect to the mounting portion 42. The coupling of the isolation member 68 within the sleeve member 64, and the manner in which the restraining member 70 restricts axial and rotational movement of the pin 52 are described with reference to FIG. 3.

Referring to FIG. 3, a sectional view of a portion of the attachment bracket 38 taken along a plane A-A′ of FIG. 2 is shown. For illustration purpose of the present disclosure, coupling of the first end 60 of the pin 56 with the first mounting portion 48 is explained in detail hereinbelow. The first mounting portion 48 is hereinafter referred to as ‘the mounting portion 48’. The mounting portion 48 includes a first surface 72, a second surface 74, and the bore 66 extending between the first surface 72 and the second surface 74. In particular, the bore 66 is a through-hole extending across a thickness ‘T1’ of the mounting portion 48. The thickness ‘T1’ of the mounting portion 48 is defined between the first surface 72 and the second surface 74. The sleeve member 64 is received through the bore 66. The sleeve member 64 is a hollow cylindrical structural sleeve received within the bore 66 of the mounting portion 48. The sleeve member 64 includes an inner surface 76 and an outer surface 78. The outer surface 78 engages with a surface of the bore 66. The sleeve member 64 has a length greater than the thickness ‘T1’ of the mounting portion 48. Such that a first end 82 and a second end 84 of the sleeve member 64 projects from the first surface 72 and the second surface 74, respectively. Further, the sleeve member 64 is welded to the mounting portion 48. In an example, a weld seam may be provided between the outer surface 78 of the sleeve member 64, and the first and second surfaces 72, 74 of the mounting portion 48. In another example, the first end 82 may be aligned with the first surface 72 of the mounting portion 48 and the second end 84 may project from the second surface 74 of the mounting portion 48. The sleeve member 64 further includes a first cross-hole 86 defined proximal to the second end 84 thereof. The first cross-hole 86 receives the restraining member 70 therethrough.

The isolation member 68 includes a first structural sleeve 88, a second structural sleeve 90 coaxially disposed within the first structural sleeve 88, and a dampening member 92. The dampening member 92 is disposed between the first structural sleeve 88 and the second structural sleeve 90. The first structural sleeve 88 is a cylindrical tube having a length greater than or equal to the thickness ‘T1’ of the mounting portion 48. Further, the length of the first structural sleeve 88 is smaller than or equal to the length of the sleeve member 64. The first structural sleeve 88 further includes an outer surface 94 in contact with the inner surface 76 of the sleeve member 64. Similarly, the second structural sleeve 90 is a cylindrical tube having a length equal to the length of the first structural sleeve 88. In an example, the length of the second structural sleeve 90 may be different from the length of the first structural sleeve 88. The second structural sleeve 90 further includes an outer surface 98, and an inner surface 100 for receiving the first end 60 of the pin 56. The inner surface 100 of the second structural sleeve 90 is in contact with a surface of the pin 56. The dampening member 92 is disposed between the first structural sleeve 88 and the second structural sleeve 90 such that the dampening member 92 is in contact with an inner surface 104 of the first structural sleeve 88 and the outer surface 98 of the second structural sleeve 90. In an example, the dampening member 92 may be integrally formed with the first structural sleeve 88 and the second structural sleeve 90 such that the isolation member 68 is formed as a single component. The dampening member 92 is used for isolating the high frequencies of the vibrations produced during the operation of the machine 10, such that damaging load applied on the work tool 18 and the high frequencies of the vibration transferring from the work tool 18 to the boom assembly 12 of the machine 10 may be minimized. In an example, the dampening member 92 may be made from elastomeric material such as a rubber. In another example, the isolation member 68 may be received within the sleeve member 64 and attached with the isolation member 68 using a press fit assembly method.

During assembly, the sleeve member 64 is received through the bore 66 and positioned with respect to the bore 66 of the mounting portion 48. Further, the weld seam is provided between the outer surface 78 of the sleeve member 64, and the first and second surfaces 72, 74 of the mounting portion 48 to rigidly attach the sleeve member 64 with the bore 66. Further, the isolation member 68 is received within the sleeve member 64 and coaxially aligned with the sleeve member 64. Specifically, the inner surface 76 of the sleeve member 64 contacts with the outer surface 94 of the first structural sleeve 88 of the isolation member 68. Furthermore, the pin 56 is coaxially aligned with the bore 66 and inserted through the second structural sleeve 90 of the isolation member 68. In particular, the pin 56 is coaxially inserted through the second structural sleeve 90 of the isolation member 68 until the first end 60 of the pin 56 is received at the mounting portion 48. Length of the pin 56 may be predefined, so that the first end 60 and the second end of the pin 56 are received at the first and second mounting portions 48, 50 respectively. In an example, diameters of the sleeve member 64 and the isolation member 68 may be predetermined so as to form a press fit between the inner surface 76 of the sleeve member 64 and the outer surface 94 of the first structural sleeve 88 of the isolation member 68. Similarly, diameters of the isolation member 68 and the first end 60 of the pin 56 may be predetermined so as to form a press fit between the inner surface 100 of the second structural sleeve 90 of the sleeve member 64 and the surface of the pin 56. Accordingly, the respective diameters of the sleeve member 64, the isolation member 68, and the pin 56 may be machined to define a predetermined tolerance. The sleeve member 64 and the isolation member 68 together form a support structure to receive the pin 56 therethrough.

A second cross-hole 106 is provided in the pin 56 proximal to the first end 60. The second cross-hole 106 is aligned with the first cross-hole 86 of the sleeve member 64 to receive the restraining member 70. Thus, the restraining member 70 is used for restricting the axial and rotational movement of the pin 56 with respect to the mounting portion 48. In the illustrated example, the restraining member 70 used for restricting the movement of the pin 56 is a bolt. The bolt has a shank portion 108 inserted through the sleeve member 64. The bolt is further engaged with a nut 110 so that the first end 60 of the pin 56 is coupled with the sleeve member 64 to restrict the axial and rotational movement of the pin 56 with respect to the mounting portion 48. In one example, the restraining member 70 may be provided at one of the first end 60 and the second end of the pin 56. In another example, the restraining member 70 may be provided at both the first end 60 and the second end of the pin 56.

In the illustrated embodiment, the sleeve member 64 has a circular cross section and the first structural sleeve 88 of the isolation member 68 has a circular cross section to contact with the inner surface 76 of the sleeve member 64. In another embodiment, cross-section of sleeve member 64 may be a square, a rectangle, or a polygon. Accordingly, the bore 66 may have a corresponding cross-section to receive the sleeve member 64. Further, the first structural sleeve 88 of the isolation member 68 may also have a corresponding cross section to contact with the inner surface 76 of the sleeve member 64. In some embodiments, the restraining member 70 may be a cotter pin, or a stud for coupling the first end 60 of the pin 56 with the sleeve member 64 for restrict axial and rotational movement of the pin 56.

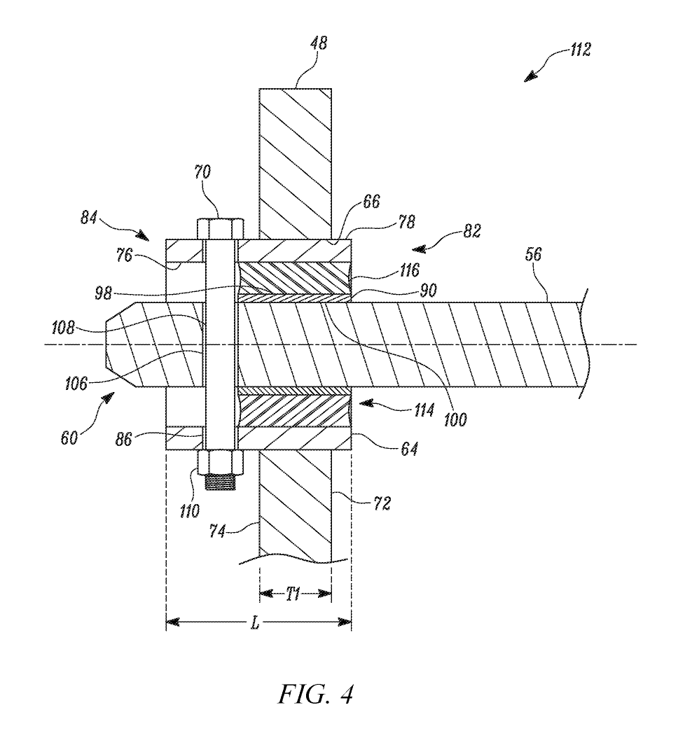

Referring to FIG. 4, a sectional view of a portion of an attachment bracket 112, according to another embodiment of the present disclosure, is illustrated. Referring to FIG. 3 and FIG. 4, the attachment bracket 112 includes the mounting portion 48 having the sleeve member 64 welded thereto similar to the attachment bracket 38. The attachment bracket 112 further includes an isolation member 114 integrally formed with the mounting portion 48 during manufacturing of the attachment bracket 112. The isolation member 114 includes the second structural sleeve 90 and a dampening member 116 disposed between the sleeve member 64 and the second structural sleeve 90. The dampening member 116 is bonded to the outer surface 98 of the second structural sleeve 90 and the inner surface 76 of the sleeve member 64. In an example, the dampening member 116 may be integrally formed with the mounting portion 48 during a casting process. Specifically, a rubber material may be poured within the sleeve member 64 and the second structural sleeve 90 such that the mounting portion 48, the sleeve member 64, and the isolation member 68 form a single component.

### INDUSTRIAL APPLICABILITY

The present disclosure relates to the attachment bracket 38 for the machine 10. The attachment bracket 38 includes the isolation member 68 provided between the work tool 18 and the boom assembly 12 of the machine 10. The attachment bracket 38 along with the isolation member 68 is essentially designed for minimize the damaging load acting on the machine 10 or the boom assembly 12. The work piece 32 of the machine 10, when subjected to damaging loads and high frequency of vibration, requires the dampening member 92 to take the damaging load generated during the operation of the machine 10. As such, the isolation member 68 is used for isolating the attachment bracket 38 from vibrations produced during the operation of the machine 10. With the deployment of the isolation member 68 in the attachment bracket 38, premature failure of linkage assembly, such as the boom assembly 12, of the machine 10 can be minimized.

Various dimensional characteristics of the first structural sleeve 88, the second structural sleeve 90, and the dampening member 92 are defined based on the frequency of the vibration caused during the operation of the machine 10. In an example, length and thickness of the first structural sleeve 88, the second structural sleeve 90, and the dampening member 92 may be defined to dampen or isolate a frequency of vibration ranging from 12 Hz to 40 Hz. Thus the isolation member 68 of the present disclosure may be implemented in various machines. Further, due to the restraining member 70, the axial and rotational movement of the pin 56 is restricted. The sleeve member 64 attached to the mounting portion 48 facilitates easy and quick assembly of the isolation member 64 with the mounting portion 48 and further enables coupling of the pin 56 therewith such that any axial and rotational movement of the pin 56 is arrested.

What is claimed is:

1. An attachment bracket having a pin for coupling a work tool to a machine, the attachment bracket comprising:
a base portion adapted to couple with the work tool;
a mounting portion extending from the base portion, and adapted to couple with the machine, the mounting portion including a first surface, a second surface, and a bore extending between the first surface and the second surface;
a sleeve member received through the bore, and attached with the mounting portion;
an isolation member received within the sleeve member, the isolation member including:
a first structural sleeve;
a second structural sleeve coaxially disposed within the first structural sleeve, and adapted to receive at least a portion of the pin; and
a dampening member disposed between the first structural sleeve and the second structural sleeve; and
a restraining member adapted to restrict axial and rotational movement of the pin with respect to the mounting portion.

2. The attachment bracket of claim 1, wherein the restraining member is received through a first cross-hole of the sleeve member and a second cross-hole of the pin.
